(19) United States
(12) Patent Application Publication
(10) Pub. No.: US 2011/0001667 A1
(43) Pub. Date: Jan. 6, 2011

(54) Antenna Control Device, Reception Device, And Antenna Control Method

(75) Inventors: Kohji Matsumura, Osaka (JP); Sumio Hanafusa, Katano-shi (JP)

Correspondence Address: NDQ&M WATCHSTONE LLP, 300 NEW JERSEY AVENUE, NW, FIFTH FLOOR, WASHINGTON, DC, 20001, US

(73) Assignee: SANYO ELECTRIC CO., LTD., Osaka (JP)

(21) Appl. No.: 12/865,569

(22) PCT Filed: Jan. 22, 2009
(86) PCT No.: PCT/JP2009/050934

§ 371 Date: Jul. 30, 2010

(30) Foreign Application Priority Data
Jan. 31, 2008 (JP) 2008-021111

(51) Int. Cl. H01Q 3/44; H01Q 23/00

(52) U.S. Cl. 342/374

(57) ABSTRACT

A reception device includes: a variable-directivity antenna; an antenna amplifier which amplifies a signal inputted from the variable-directivity antenna; a regulator which supplies DC power to the antenna amplifier; a full wave rectification unit which supplies the DC power to the regulator; a signal line; a DC power source; and a switching unit which switches connection with the DC power source. DC voltage is applied to the DC power source by the signal line so as to control the directivity of the variable-directivity antenna. Moreover, the DC power is supplied to the regulator via the full wave rectification unit. When the connection of the switching unit is switched, the DC voltage supplied to the variable-directivity antenna is reversed between positive and negative voltage but the DC voltage supplied to the regulator is not reversed.

### TECHNICAL FIELD

The present invention relates to an antenna control device and an antenna control method that are used for a communication apparatus that performs radio communication. Besides, the present invention relates to a reception device that uses this antenna control device.

### BACKGROUND ART

In recent years, because of development of a digital compression coding technology and a high-speed communication technology, digitalization in broadcasting communication by means of a communications satellite and a ground wave and digitalization in mobile communication that uses a mobile phone and the like have been put into practical use. And, because of achievement of the digitalization in broadcasting signal and mobile communication, the digital communication technology has been used in various fields such as vehicle digital broadcasting reception, portable mobile communication, radio LAN and the like.

In a communication device that uses such a communication technology, for example, in a reception device, an antenna is used to perform good reception. Especially, a variable-directivity antenna that changes the directivity in a reception direction to allow good reception of a signal is used in some cases.

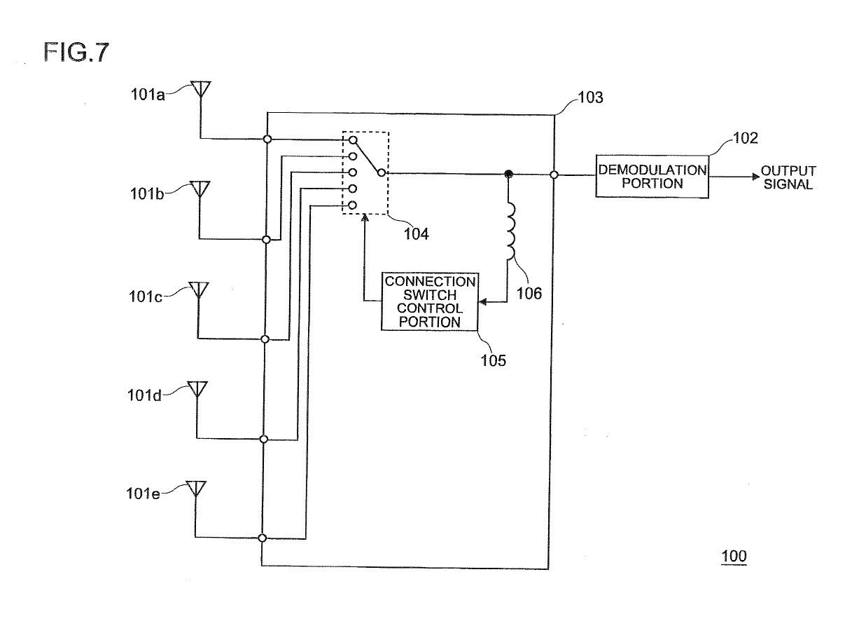

In a case where a variable-directivity antenna is used, an antenna control device is necessary to control the directivity of the variable-directivity antenna. As the antenna control device, there is an antenna control device that is proposed in a patent document 1, for example. FIG. 7 illustrates a block diagram showing a schematic structure of a reception device that includes the antenna control device proposed in the patent document 1. As shown in FIG. 7, a reception device 100 includes: a plurality of antennas 101a to 101e; a demodulation portion 102 that demodulates signals received by the antennas 101a to 101e; and a switch portion 103 that switches the connection between the plurality of antennas 101a to 101e and the demodulation portion 102 and transmits a signal received from a desired antenna to the demodulation portion. Besides, the switch portion 103 includes: a connection switch 104 that switches the connection between the plurality of antennas 101a to 101e and the demodulation portion 102; a connection switch control portion 105 that controls the connection of the connection switch 104; and an inductor 106 that prevents signals received by the antennas 101a to 101e from being input into the connection switch control portion 105. And, based on a signal that is output from the demodulation portion 102 to the switch portion 103 and input into the connection switch control portion 105 via the inductor 106, the connection switch control portion 105 controls the connection of the connection switch 104. According to this structure, it becomes possible to perform input control of a signal, which is received by a desired antenna of the antennas 101a to 101e, into the demodulation portion 102.

Patent document 1: JP-A-1993-14901

### DISCLOSURE OF THE INVENTION

### Problems to be Solved by the Invention

However, according to the structure that uses the switch portion 103 which switches the connection between each of the plurality of antennas 101a to 101e and the demodulation portion 102, the reception device 100 becomes too large. Besides, because it is necessary to dispose a signal line from each of the plurality of antennas 101a to 101e to the switch portion 103, the structure of the reception device 100 becomes complicated.

Besides, to control the switching by the switch portion 103, if a structure is employed, in which a signal is output from the demodulation portion 102 to the switch portion 103, the demodulation portion 103 needs a modulation device that generates a signal; and the switch portion 103 needs a demodulation device that demodulates a signal. Because of this, the reception device 100 becomes larger and more complicated.

In light of the problems, it is an object of the present invention to provide an antenna control device, a reception device, and an antenna control method that achieve size reduction and simplification.

### Means for Solving the Problem

To achieve the object, an antenna control device according to the present invention is an antenna control device for a communication device that includes: an antenna portion that includes an antenna which performs radio communication of a signal; and a signal conversion portion that is connected to the antenna portion via a signal line and converts a signal; the antenna control device includes: a direct-current power supply that is disposed in the signal conversion portion and supplies a direct-current voltage: a switch portion that is disposed in the signal conversion portion and switches connection between the direct-current power supply and the signal line, thereby applying a direct-current voltage that has either voltage value of a first positive voltage value and a second negative voltage value to the signal line; and an antenna switch portion that is disposed in the antenna portion and switches a characteristic of the antenna; wherein based on a voltage value of the direct-current voltage applied to the signal line, the antenna switch portion switches the characteristic of the antenna.

A reception device according to the present invention having: an antenna portion that has an antenna which receives a signal; and a demodulation portion that is connected to the antenna portion via a signal line and demodulates a signal input via the signal line; the reception device includes: a direct-current power supply that is disposed in the demodulation portion and supplies a direct-current voltage; a switch portion that is disposed in the demodulation portion and switches connection between the direct-current power supply and the signal line, thereby applying a direct-current voltage that has either voltage value of a first positive voltage value and a second negative voltage value to the signal line; and an antenna switch portion that is disposed in the antenna portion and switches a characteristic of the antenna; wherein based on a voltage value of the direct-current voltage applied to the signal line, the antenna switch portion switches the characteristic of the antenna.

Besides, the reception device having the above structure may further include; an antenna amplifier that is disposed in the antenna portion and amplifies a signal input into the antenna; and a full-wave rectification portion that is disposed in the antenna portion, applies full-wave rectification to the direct-current voltage applied to and input into the signal line, thereby generating a direct-current voltage that is supplied to the antenna amplifier.

According to this structure, even if the direct-current voltage that is supplied from the signal line to the antenna portion is switched to a positive voltage value or a negative voltage value, by performing the full-wave rectification by means of the full-wave rectification portion, it becomes possible to continuously generate a positive voltage. Accordingly, it becomes possible to stably supply a direct-current voltage to the antenna amplifier.

Besides, in the reception device having the above structure, the full-wave rectification portion may include a bridge circuit that has four diodes. According to this structure, it is possible to achieve size reduction and simplification of the full-wave rectification portion.

Besides, the reception device having the above structure may include a regulator that adjusts the voltage generated from the full-wave rectification portion and supplies a direct-current voltage to the antenna portion. According to this structure, it becomes possible to supply a direct-current voltage having a desired magnitude and less fluctuation to the antenna amplifier.

Besides, in the reception device having the above structure, the absolute value of the first voltage value and the absolute value of the second voltage value may be equal to each other. According to this structure, it becomes possible to keep the magnitude of the direct-current voltage output from the full-wave rectification portion at nearly a constant value. Accordingly, it becomes easy to adjust the direct-current voltage when it is supplied to the antenna amplifier. Besides, if the absolute value is nearly equal to the magnitude of the direct-current voltage supplied to the antenna amplifier, it becomes unnecessary to perform voltage increase and voltage decrease, and it becomes possible to adjust the direct-current voltage more easily. Accordingly, it becomes possible to simplify the structure of the regulator and the like that adjust the direct-current voltage.

Besides, in the reception device having the above structure, the antenna switch portion may switch directivity of the antenna in a reception direction.

According to this structure, it becomes possible to strengthen the directivity in a direction in which a reception situation becomes good to perform reception. Accordingly, it becomes possible to improve the reception situation by switching the characteristic of the antenna.

Besides, in the reception device having the above structure, the antenna may include: at least two parasitic elements whose one end is grounded; and an electric-power reception element that is disposed between the parasitic elements and inputs a received signal into the demodulation portion via the signal line; and the antenna switch portion includes a variable-reactance element which is disposed in each of the parasitic elements and whose reactance to a received signal is variable; wherein the reactance of the variable-reactance element is decided based on the voltage value of the direct-current voltage applied to the signal line.

According to this structure, it becomes possible to change the directivity of the antenna by only changing the reactance of the reactance element. Here, a parasitic element provided with a reactance element that has a small reactance operates as a reflection element; and a parasitic element provided with a reactance element that has a large reactance operates as a waveguide element.

Besides, in the reception device having the above structure, the variable-reactance element is a varactor diode; an anode of one of the varactor diodes is so disposed as to be situated on a one-end side of the parasitic element that is grounded; a cathode of one of the other of the varactor diodes is so disposed as to be situated on a one-end side of the parasitic element that is grounded; a capacitor is disposed between the varactor diode and the grounded one end of the parasitic element; and the direct-current voltage applied to the signal line may be applied across the varactor diode of the parasitic element and the capacitor.

According to this structure, it is possible to control the reactance of each varactor diode to a signal by only applying a positive or negative voltage, in other words, it is possible to control the directivity of the antenna. Especially, because it is possible to use the direct-current voltage input via the signal line as it is, an device and the like that determine the input direct-current voltage become unnecessary. Accordingly, it is possible to achieve size reduction and simplification of the reception device.

Besides, in the reception device having the above structure, based on the signal processed by the demodulation portion, the switch portion may switch the connection between the direct-current power supply and the signal line.

According to this structure, it becomes possible to detect deterioration of the reception situation from the signal processed by the demodulation portion and switch the connection. Accordingly, in a case where it becomes necessary to improve the reception situation, it is possible to switch the directivity of the antenna.

Besides, in the reception device having the above structure, by comparing the signal that is processed by the demodulation portion in a case where a direct-current voltage having the first voltage value is applied to the signal line and the signal that is processed by the demodulation portion in a case where a direct-current voltage having the second voltage value is applied to the signal line with each other, the connection by the switch portion may be decided. According to this structure, it is possible to keep the reception situation in the best state.

Besides, in the reception device having the above structure, the signal line may be a coaxial line that includes an inner conductive body and an outer conductive body disposed around the inner conductive body, or the signal line may be a feeder line that includes two conductive lines.

Especially, the structure that uses the feeder line is employed, to whichever conducive line a direct-current voltage having a large absolute value is applied, it is possible to prevent an electricity leak.

Besides, an antenna control method according to the present invention is an antenna control method for a communication device that includes an antenna portion that has an antenna which performs radio communication of a signal; and a signal conversion portion that is connected to the antenna portion via a signal line and converts a signal; the antenna control method comprising the steps for: applying a direct-current voltage that has either voltage value of a first positive voltage value and a second negative voltage value to the signal line; and controlling a characteristic of the antenna based on a voltage value of the direct-current voltage applied to the signal line.

### Advantages of the Invention

According to the present invention, only by switching the connection between the direct-current power supply and the signal line and by switching the sign of the direct-current voltage supplied to the signal line, it is possible to easily switch the characteristic of the antenna. Accordingly, because it becomes unnecessary to additionally dispose a switch device that switches the connection between the antenna and the signal conversion portion, it is possible to achieve size reduction and simplification of the antenna control device and the communication device.

Besides, it becomes possible to make it unnecessary to dispose a modulation device, which generates a signal to switch the characteristic of the antenna, in the signal conversion portion and even to dispose a demodulation device, which demodulates a signal that switches the characteristic of the antenna, in the antenna portion. Accordingly, it becomes possible to achieve further size reduction and simplification of the antenna control device and the communication device.

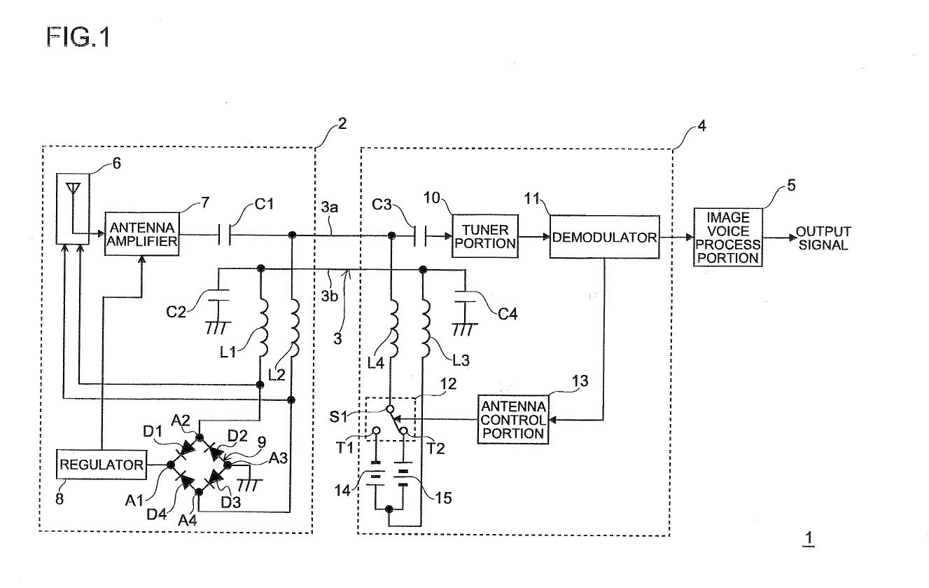

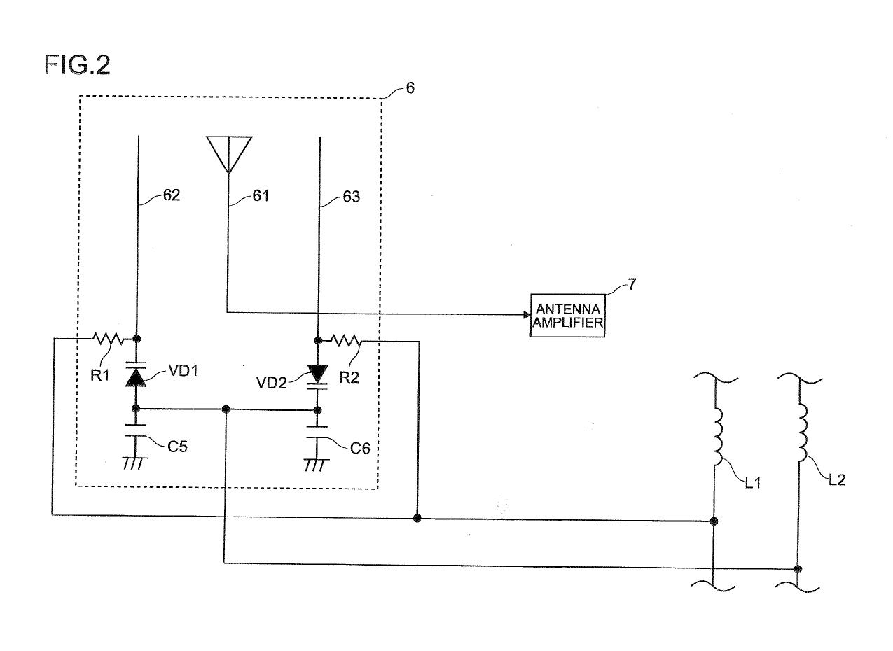

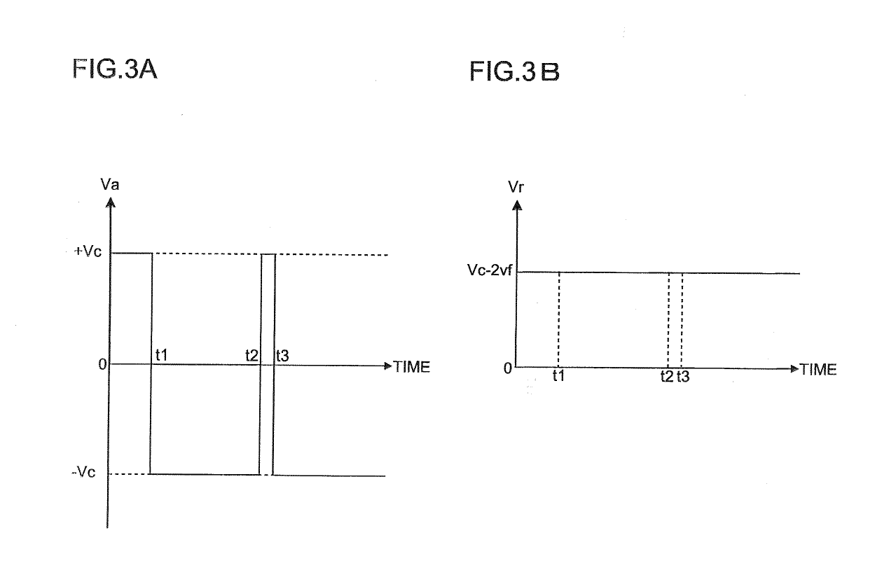

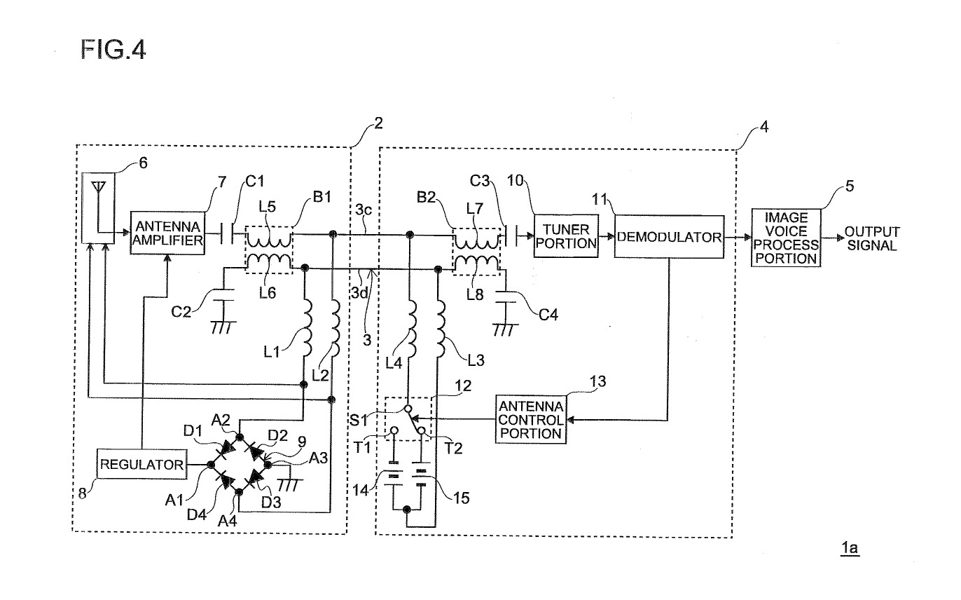

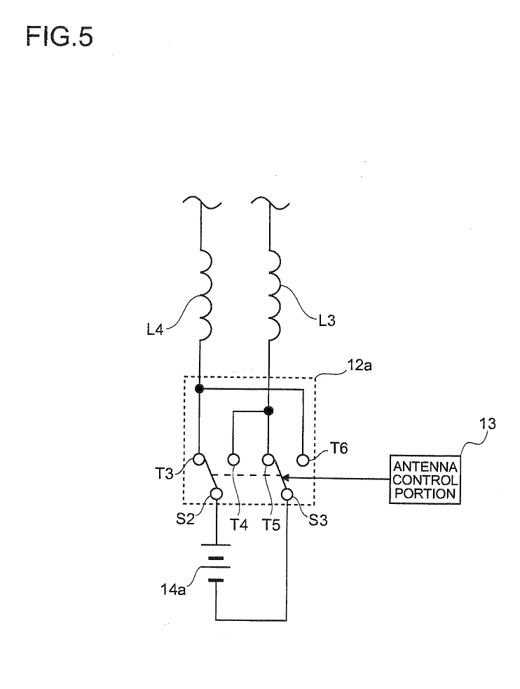

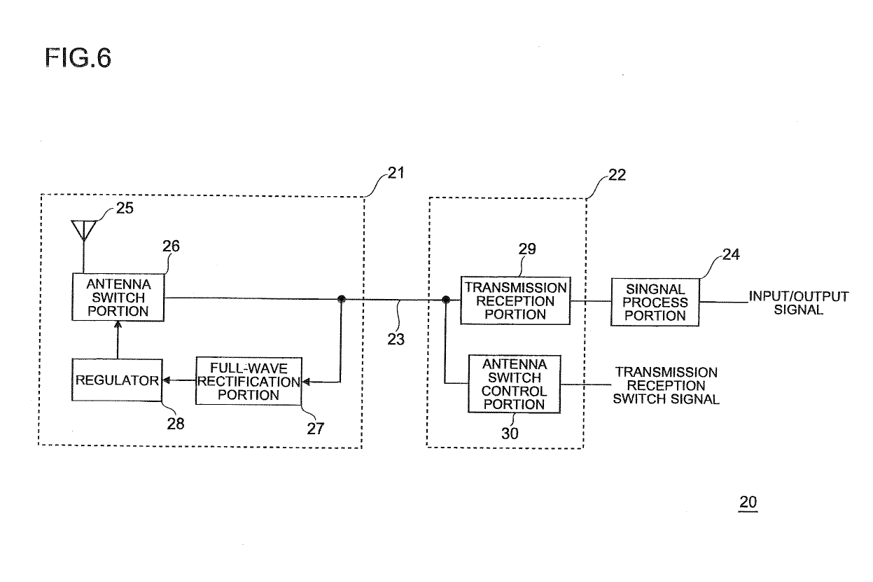

### BRIEF DESCRIPTION OF THE DRAWINGS

[FIG. 1] is a block diagram showing a structure of a reception device according a first embodiment of the present invention.

[FIG. 2] is a block diagram showing an example of a structure of a variable-directivity antenna.

[FIG. 3A] is a graph showing a relationship between voltage value Va and time.

[FIG. 3B] is a graph showing a relationship between voltage value Vr and time.

[FIG. 4] is a block diagram showing a structure of a reception device according a second embodiment of the present invention.

[FIG. 5] is a circuit diagram showing another example of a direct-current power supply and a switch portion.

[FIG. 6] is a block diagram showing an overview of a structure of a communication device according to another embodiment of the present invention.

[FIG. 7] is a block diagram showing a structure of a conventional reception device.

### LIST OF REFERENCE SYMBOLS

[1, 1a] reception devices

[2] antenna portion

[3] signal line

[3a] inner conductive body

[3b] outer conductive body

[3c, 3d] conductive lines

[4] demodulation portion

[5] image voice process portion

[6] variable-directivity antenna

[61] electricity reception element

[62, 63] parasitic elements

[7] antenna amplifier

[8] regulator

[9] full-wave rectification portion

[A1 to A4] contacts

[D1 to D4] diodes

[10] tuner portion

[11] demodulator

[12, 12a] switch portions

[20] communication device

[21] antenna portion

[22] modulation/demodulation portion

[23] signal line

[24] signal process portion

[25] antenna

[26] antenna switch portion

[27] full-wave rectification portion

[28] regulator

[29] transmission and reception portion

[30] antenna control portion

[S1 to S3] terminals

[T1 to T6] contacts

[13] antenna control portion

[14, 14a, 15] direct-current power supplies

[B1, B2] baluns

[L1 to L6] inductors

[R1, R2] resistors

[VD1, VD2] varactor diodes

[C1 to C6] capacitors

### BEST MODE FOR CARRYING OUT THE INVENTION

### First Embodiment

<Structure of Reception Device>

First, hereinafter, a case where an antenna control device and an antenna control method according the present invention are applied to a reception device is described. First, a structure of a reception device according a first embodiment is described by using FIG. 1. FIG. 1 is a block diagram showing a structure of a reception device according to the first embodiment of the present invention.

Besides, hereinafter, an example, in which the present invention is applied to a reception device 1 that is a reception device for digital terrestrial television broadcasting of the ISDB-T (Integrated Services Digital Broadcasting for Terrestrial) type in which a signal is digitally modulated by an orthogonal frequency division multiplex (OFDM) system is transmittted, is described; however, the broadcasting of another communication type may be received and the present invention may be applied to a reception device that receives a signal other than a signal for the television broadcasting.

The reception device 1 shown in FIG. 1 includes: an antenna portion 2 that receives a signal; a demodulation portion 4 that modulates a signal received by the antenna portion 2; a signal line 3 that connects the antenna portion 2 and the demodulation portion 4 with each other; and an image voice process portion 5 that converts a signal output from the demodulation portion 4 into a signal that is displayable and reproducible in an output device (not shown) such as a display device, a speaker and the like.

In the present embodiment, a coaxial cable is used as the signal line 3. Specifically, the signal line 3 that is a coaxial cable includes: an inner conductive body 3a that is disposed in a central portion and surrounded by, that is, clad in an insulation body (not shown) such as a resin or the like; and an outer conductive body 3b that is so disposed as to surround the insulation body. The outer conductive body 3b blocks the influence of an electromagnetic wave from outside on a signal that flows in the inner conductive body 3a and prevents an electromagnetic-wave leak from inside.

The antenna portion 2 includes: a variable-directivity antenna 6 into which a high-frequency (Radio Frequency; hereinafter called RF) signal is input and which is able to control the directivity in a reception direction; an antenna amplifier 7 that amplifies a signal output from the variable-directivity antenna 6; a regulator 8 that supplies direct-current, that is, DC electric power to the antenna amplifier 7; and a full-wave rectification portion 9 whose terminal A1 is connected to the regulator 8.

The full-wave rectification portion 9 includes: a diode D1 whose cathode is connected to the terminal A1 and whose anode is connected to a terminal A2; a diode D2 whose cathode is connected to the terminal A2 and whose anode is connected to a terminal A3; a diode D3 whose anode is connected to the terminal A3 and whose cathode is connected to a terminal A4; and a diode D4 whose anode is connected to the terminal A4 and whose cathode is connected to the terminal A1. Besides, the terminal A3 is grounded.

The antenna portion 2 further includes: a capacitor C1 whose one end is connected to the antenna amplifier 7 and whose other end is connected to the inner conductive body 3a; a capacitor C2 whose one end is grounded and whose other end is connected to the outer conductive body 3b; an inductor L1 whose one end is connected to the outer conductive body 3b and whose other end is connected to the terminal A2 of the full-wave rectification portion 9; and an inductor L2 whose one end is connected to the inner conductive body 3a and whose other end is connected to the terminal A4 of the full-wave rectification portion 9. A connection node between the inductor L1 and the terminal A2 and a connection node between the inductor L2 and the terminal A4 are connected to the variable-directivity antenna 6.

The demodulation portion 4 includes: a tuner portion 10 that selects and obtains a desired-frequency signal from input signals and performs frequency conversion and amplification; a demodulator 11 that demodulates a signal output form the tuner portion 10; a switch portion 12 that switches the directivity of the variable-directivity antenna 6; an antenna control portion 13 that controls the switch portion 12 based on a signal output from the demodulator 11; and DC power supplies 14, 15. The switch portion 12 is a switch that connects a terminal S1 with either of two contacts T1, T2. Besides, a negative pole of the DC power supply 14 is connected to the contact T1; and a positive pole of the DC power supply 15 is connected to the contact T2.

The demodulation portion 4 further includes: a capacitor C3 whose one end is connected to the tuner portion 10 and whose other end is connected to the inner conductive body 3a; a capacitor C4 whose one end is grounded and whose other end is connected to the outer conductive body 3b; an inductor L3 whose one end is connected to the outer conductive body 3b and whose other end is connected to a connection node between the positive pole of the DC power supply 14 and the negative pole of the DC power supply 15; and an inductor L4 whose one end is connected to the inner conductive body 3a and whose other end is connected to the terminal S1 of the switch portion 12.

The capacitors C1, C3 are so disposed as to prevent a DC voltage from joining a signal to be input into the tuner portion 10 when applying a DC voltage to the inner conductive body 3a. Besides, the inductors L1 to L4 are so disposed as to prevent a signal from being put on a DC voltage and being input into the full-wave rectification portion 9 and the variable-directivity antenna 6; and to prevent noise and the like generated by the switching of the switch portion 12 from being input into the signal line 3. Besides, the capacitors C2, C4 are so disposed as to ground an alternating voltage flowing in the outer conductive body 3b and to prevent an input DC voltage from being grounded.

<Reception Operation>

Next, operation of the reception device 1 having the above structure is described by using FIG. 1. After the reception operation is started, first, a RF signal is received by the variable-directivity antenna 6. The received RF signal is amplified by the antenna amplifier 7 and input into the tuner portion 10 via the inner conductive body 3a of the signal line 3. The tuner portion 10 selects a desired-frequency signal from the input RF signals, amplifies the selected signal and applies frequency conversion to the amplified signal to obtain a signal of an intermediate frequency (Inter frequency; hereinafter, called IF). Besides, the tuner portion 10 also amplifies the IF signal after the frequency conversion.

The IF signal output from the tuner portion 10 is input into the demodulator 11 and undergoes demodulation. The demodulation interacts with the modulation type applied to the signal input from the antenna; and as modulation types, there are, for example, QAM (Quadrature Amplitude Modulation), QPSK (Quadrature Phase Shift Keying), DQPSK (Differential Quadrature Phase Shift Keying) and the like. Besides, in the demodulator 11, equalization is performed to correct a distortion of a signal that is generated during the transmission. As this equalization method, there is a method for correcting a signal by obtaining a transmission-line characteristic from a reference signal that is contained in the signal and has a known intensity. Besides, this correction is performed in both directions of a frequency axis and a time axis. Here, before performing the equalization, a high-speed Fourier transform may be applied to the signal to convert the signal into a signal on the frequency axis.

The signal that is demodulated by the demodulator 11 as described above is input into the image voice process portion 5 and converted into an output signal that is displayable and reproducible in an output device such as a display device, a speaker and the like. Here, not only signals of an image and a voice but also other data signals may be contained in this output signal.

<Variable-Directivity Antenna>

Next, an example of the above variable-directivity antenna 6 is described by using FIG. 2. FIG. 2 is a block diagram showing an example of a structure of the variable-directivity antenna. Here, in the present example, a case where an ESPAR (Electronically Steerable Passive Array Radiator) antenna is described as the example.

As shown in FIG. 2, the variable-directivity antenna 6 includes: an electricity reception element 61 that receives an electromagnetic signal and inputs the electromagnetic signal into the antenna amplifier 7; and parasitic elements 62, 63 that are disposed around the electricity reception element 61 and controls the directivity. Besides, the variable-directivity antenna 6 includes: a resistor R1 whose one end is connected to the parasitic element 62; a resistor R2 whose one end is connected to the parasitic element 63; a varactor diode VD1 that is disposed in the parasitic element 62 and one end of the resistor R1 connected to the parasitic element 62 is situated on a cathode side; a varactor diode VD2 that is disposed in the parasitic element 63 and one end of the resistor R2 connected to the parasitic element 63 is situated on an anode side; a capacitor CS whose one end is connected to an anode of the varactor diode VD1 and whose other end is grounded; and a capacitor C6 whose one end is connected to a cathode of the varactor diode VD2 and whose other end I is grounded.

A connection node between the anode of the varactor diode VD1 and one end of the capacitor C5 is connected to a connection node between the cathode of the varactor diode VD2 and the one end of the capacitor C6. And, this connection node is connected to a connection node between the inductor L1 and the terminal A2 of the full-wave rectification portion 9. Besides, the other end of the resistor R1 and the other end of the resistor R2 is connected to each other; and this connection node is connected to a connection node between the inductor L2 and the terminal A4 of the full-wave rectification portion 9.

In the variable-directivity 6 in the present example, it is possible to control the directivity by controlling the DC voltage applied to the varactor diodes VD1, VD2. First, a case where the potentials on the anode side of the varactor diode VD1 and on the cathode side of the varactor diode VD2 are kept larger than the potentials on the cathode side of the varactor diode D1 and on the anode side of the varacto diode DV2; and a voltage is applied to the varactor diodes VD1, VD2 is described as an example. In this case, a forward-bias voltage is applied to the varactor diode VD1; and a reverse-bias voltage is applied to the varactor diode VD2. Here, it is supposed that the applied voltages are higher than the forward drop voltages of the varactor diodes VD1, VD2.

Here, because the capacity of the varactor diode VD1 to which the forward-bias voltage is applied becomes large (the reactance becomes small), a RF signal easily passes through the varactor diode VD1, which is seemingly a grounded state. Accordingly, the parasitic element 62 operates as a reflection element. On the other hand, because the capacity of the varactor diode VD2 to which the reverse-bias voltage is applied becomes small (the reactance becomes large), it becomes hard for a RF signal to pass through the varactor diode VD2. Accordingly, the parasitic element 63 operates as a waveguide element. As described above, by applying a forward-bias voltage to the varactor diode VD1 and a reverse-bias voltage to the varactor diode VD2, it is possible to increase the directivity on the parasitic element 63 side.

In contrast, a case where the potentials on the anode side of the varactor diode VD1 and on the cathode side of the varactor diode VD2 are kept smaller than the potentials on the cathode side of the varactor diode VD1 and on the anode side of the varactor diode VD2 is described. In this case, a reverse-bias voltage is applied to the varactor diode VD1; and a forward-bias voltage is applied to the varactor diode VD2.

Here, in contrast with the above case, because the capacity of the varactor diode VD1 becomes small (the reactance becomes large); and the capacity of the varactor diode VD2 becomes large (the reactance becomes small). Accordingly, the parasitic element 62 through which a RF signal is unlikely to pass operates as a waveguide element; and the parasitic element 63 through which a RF signal is easily grounded operates as a reflection element. As described above, by applying a reverse-bias voltage to the varactor diode VD1 and a forward-bias voltage to the varactor diode VD2, it is possible to increase the directivity on the parasitic element 62 side.

Besides, the capacitors C5, C6 are so disposed as to prevent the applied DC voltage from being grounded. And, the RF signal that passes through the varactor diodes VD1, VD2 is grounded via these capacitors C5, C6.

<Variable-Directivity Antenna Control Operation>

Next, specific control operation of the above variable-directivity antenna is described by using FIGS. 1, 2, 3A and 3B. FIG. 3A is a graph showing a relationship between the time and the voltage value Va that is a difference between the potential of the inner conductive body 3a of the signal line 3 and the potential of the outer conductive body 3b of the signal line 3; and FIG. 3B is a graph showing a relationship between the time and the voltage value Vr that is a difference between the potential of the terminal A1 of the full-wave rectification portion 9 and the ground potential and is supplied to the regulator 8. The graphs in FIGS. 3A and 3B each represent a change in the voltage value caused by the control operation.

Besides, it is supposed that the forward drop voltages of the diodes D1 to D4 are all Vf; and the output voltages from the DC power supplies 14, 15 are all Vc. Further, it is supposed that the voltage value Va=(the potential of the inner conducive body 3a)−(the potential of the outer conductive body 3b); and the voltage value Vr=(the potential of the terminal A1 of the full-wave rectification portion 9)−(the ground potential).

First, a case where as an initial state, for example, the terminal S1 and the contact T2 are connected to each other in the switch portion 12 is described. Here, the potential of a DC component in the outer conductive body 3b is made lower than the ground potential by Vf by the diode D2, that is, becomes −Vf. On the other hand, the potential of a DC component in the inner conductive body 3a is made larger than −Vf by Vc by the DC power supply 15, that is, becomes Vc−Vf. Accordingly, as represented from the times 0 to t1 in FIG. 3A, the voltage value Va=(Vc−Vf)−(−Vf)=+Vc. Hereinafter, the state in which the voltage value Va becomes a positive value as described above is represented as a state in which a positive voltage is applied to the signal line 3.

Besides, the potential Vc−Vf of the inner conductive body 3a is input into the terminal A4 of the full-wave rectification portion 9. And, because the potential is lowered by Vf by the diode D4, the potential of the terminal A1 becomes Vc−2Vf. Because of this, the voltage value Vr input into the regulator 8 becomes Vc−2Vf as represented from the times 0 to t1 in FIG. 3B.

On the other hand, the potentials on the anode side of the varactor diode VD1 and on the cathode side of the varactor diode VD2 in FIG. 2 become a potential that has the same magnitude as the potential input into the terminal A4 of the full-wave rectification portion 9, that is, becomes Vc−Vf. Besides, the potentials at the other ends of the resistors R1, R2 become a potential that has the same magnitude as the potential input into the terminal A2 of the full-wave rectification portion 9, that is, becomes −Vf. Accordingly, in the time of 0 to t1, because a forward-bias voltage is applied to the varactor diode VD1; and a reverse-bias voltage is applied to the varactor diode VD2, the directivity on the parasitic element 63 side becomes large.

Next, the switching operation of the directivity of the variable-directivity antenna 6 is described. In the graphs in FIGS. 3A and 3B, the switching operation is performed at the time t1. The switching operation is performed when the antenna control portion 13 switches the connection of the switch portion 12. Besides, at this time, the antenna control portion 13 performs the switching based on a signal output from the demodulator 11. More specifically, in a case where the antenna control portion 13 detects deterioration of the reception situation based on the signal output from the demodulator 11, the antenna control portion 13 switches the switch portion 12.

As signals output from the demodulator 11, for example, there are a signal that indicates an average electric power of signals such as IF signals and the like which are processed in the demodulator 11; a signal that indicates a CN ratio that is a ratio of the magnitude of a carrier wave to the magnitude of noise; a signal that indicates a signal error rate in a demodulation time and the like. In a case where deterioration of the reception situation is detected by using a signal that indicates an average electric power, it is possible to determine that the reception situation deteriorates in a case where the average electric power becomes too smaller or too larger than a predetermined value. Besides, in a case where a CN ratio is used, it is possible to determine that noise is large and the reception situation deteriorates in a case where the CN ratio becomes smaller than a predetermined value. Besides, in a case where a signal error rate is used, it is possible to determine that a correct reception operation is not performed and the reception situation deteriorates in a case where the signal error rate becomes larger than a predetermined value.

As in the above example, if the antenna control portion 13 detects deterioration of the reception situation, the antenna control portion 13 switches the connection of the switch portion 12. In the present example, because the terminal S1 and the contact T2 are connected to each other in the time of 0 to t1, the connection of the switch portion 12 is switched in such a way that the terminal S1 and the contact T2 are connected to each other at the time t1.

If the connection of the switch portion 12 is switched, the potential of a DC component in the inner conductive body 3a is made lower than the ground potential by Vf by the diode D3, that is, becomes −Vf. On the other hand, the potential of a DC component in the outer conductive body 3b is made larger than −Vf by Vc by the DC power supply 14, that is, becomes Vc−Vf. Accordingly, as represented in a time of t1 to t2 in FIG. 3A, the voltage value Va=(−Vf)−(Vc−Vf)=−Vc. Hereinafter, the state in which the voltage value Va becomes a negative value as described above is represented as a state in which a negative voltage is applied to the signal line 3.

Besides, the potential Vc−Vf of the outer conductive body 3b is input into the terminal A2 of the full-wave rectification portion 9. And, because the potential is lowered by Vf by the diode D1, the potential of the terminal A1 becomes Vc−2Vf. Because of this, the voltage value Vr input into the regulator 8 becomes Vc−2Vf as represented in a time of t1 to t2 in FIG. 3B. Accordingly, the voltage value Vr supplied to the regulator 8 does not change even if the connection of the switch portion 12 is switched.

Moreover, here, the potentials on the anode side of the varactor diode VD1 and on the cathode side of the varactor diode VD2 in FIG. 2 become a potential that has the same magnitude as the potential input into the terminal A4 of the full-wave rectification portion 9, that is, becomes −Vf. On the other hand, the potentials at the other ends of the resistors R1, R2 become a potential that has the same magnitude as the potential input into the terminal A2 of the full-wave rectification portion 9, that is, becomes Vc−Vf. Accordingly, in the time of t1 to t2, because a reverse-bias voltage is applied to the varactor diode VD1; and a forward-bias voltage is applied to the varactor diode VD2, the directivity on the parasitic element 62 side becomes large.

Besides, FIGS. 3A and 3B show that thereafter, in a similar way, the switching operation is performed at each of the times t2, t3. Each time the switching operation is performed, the sign of the DC voltage applied to the signal line 3 is switched and the directivity of the variable-directivity antenna 6 is switched. Because of this, the state in the time of t2 to t3 and the state in the time of 0 to t1 become equal to each other. Besides, the state after the time t3 and the state in the time of t1 to t2 become equal to each other.

According to the above structure of the reception device 1, by only switching the connection of the DC power supplies 14, 15 to switch the sign of the DC voltage applied to the signal line 3, it becomes possible to easily switch the directivity of the variable-directivity antenna 6. Because of this, because it becomes unnecessary to additionally dispose a switch device like the switch portion 103 in FIG. 7 showing the conventional example, it becomes possible to achieve size reduction and simplification of the reception device 1.

Besides, the DC voltage applied to the signal line 3 is not modulated before a signal is sent to the antenna portion 2, it becomes unnecessary to dispose a modulation device in the demodulation portion 4 and to dispose a demodulation device that demodulates a modulated DC voltage in the antenna portion 2. Accordingly, it becomes possible to achieve further size reduction and simplification of the reception device 1.

Besides, as described above, even if the directivity of the variable-directivity antenna 6 is switched by switching the sign of the DC voltage applied to the signal line 3, as shown in FIG. 3B, it is possible to continuously keep the DC voltage supplied to the regulator 8 at a positive voltage value. Because of this, the adjustment of the DC voltage at the regulator 8 becomes easy and it becomes possible to achieve size reduction and simplification of the reception device 1.

Here, the graphs shown in FIGS. 3A and 3B are schematic diagrams; and the voltage values Va, Vr may change more or less in an actual operation. For example, in FIG. 3A, the case where the voltage value Va sharply changes immediately after the times t1, t2, and t3 is described; the rising and the falling may take a slight time. Besides, in FIG. 3B, the voltage value Vr may slightly change immediately after the times t1, t2, and t3. Here, both changes occur in a short time; and the graphs shown in FIGS. 3A and 3B are obtained as a whole.

### Second Embodiment

Next, a second embodiment of the present invention is described by using FIG. 4. FIG. 4 is a block diagram showing a structure of a reception device in the second embodiment of the present invention. In the present embodiment as well, like the first embodiment, the case where the antenna control device and the antenna control method are applied to the reception device is described. Here, the same portions as those of the reception device 1 in the first embodiment are indicated by the same reference numbers and detailed description of them is skipped.

The reception device 1a in the present embodiment is different from the reception device 1 in the first embodiment in that instead of a coaxial line, a feeder line is used as the signal line 3. In other words, the antenna portion 2 and the demodulation portion 4 are connected to each other via two conductive lines 3c, 3d. Besides, baluns B1, B2 are connected to both ends of the conductive lines 3c, 3d, respectively. The balun B1 includes: an inductor L5 whose one end is connected to the other end of the capacitor C1 and whose other end is connected to the conductive line 3c; and an inductor L6 whose one end is connected to the other end of the capacitor C2 and whose other end is connected to the conductive line 3d. The balun B2 includes: an inductor L7 whose one end is connected to the other end of the capacitor C3 and whose other end is connected to the conductive line 3c; and an inductor L8 whose one end is connected to the other end of the capacitor C4 and whose other end is connected to the conductive line 3d.

In other words, the conductive line 3c corresponds to the inner conductive body 3a of the reception device 1 in the first embodiment shown in FIG. 1; and the conductive line 3d corresponds to the outer conductive body 3b. Besides, the reception device 1a has the same structure as the reception device 1 in the first embodiment except that the inductors L5 to L8 of the baluns B1, B2 are disposed respectively between the capacitors C1 to C4 and the conductive lines 3c, 3d.

The reception operation is also the same as the reception device 1 in the above first embodiment. However, as for the transmission method via the signal line 3 between the antenna portion 2 and the demodulation portion 4, the first embodiment and the second embodiment are different from each other. Specifically, the reception device 1 in the first embodiment performs an unbalanced-type transmission by using a coaxial line; however, the reception device 1a in the present embodiment performs a balanced-type transmission by using the baluns B1, B2 and a feeder line.

Besides, the control operation of the variable-directivity antenna 6 is also the same as the reception device 1 in the above first embodiment. In other words, the directivity of the variable-directivity antenna 6 is switched by switching the connection of the switch portion 12. Accordingly, like the reception device 1 in the first embodiment, it becomes possible to easily switch the directivity of the variable-directivity antenna 6.

Because of this, because it becomes unnecessary to additionally dispose a switch device like the switch portion 103 in FIG. 7 showing the conventional example, it becomes possible to achieve size reduction and simplification of the reception device 1a. Besides, the DC voltage applied to the signal line 3 is not modulated before a signal is sent to the antenna portion 2, it becomes unnecessary to dispose a modulation device in the demodulation portion 4 and to dispose a demodulation device that demodulates a modulated DC voltage in the antenna portion 2. Accordingly, it becomes possible to achieve further size reduction and simplification of the reception device 1a.

Besides, because it is possible to continuously keep the DC voltage supplied to the regulator at a positive voltage value, the adjustment of the DC voltage at the regulator 8 becomes easy and it becomes possible to achieve size reduction and simplification of the reception device 1a.

Besides, in the reception device 1 in the first embodiment, there are some cases where a high potential Vc−Vf is applied to the outer conductive body 3b that is usually grounded to have a reference potential and functions as a shield against a signal that flows in the inner conductive body 3a. In this case, for example, if the outer conductive body 3b is used in a naked state at a connector, there is a risk that electricity leaks from the outer conductive body 3b. On the other hand, it is premised that in the feeder line used in the reception device 1a in the present embodiment, a signal flows in each of the two conductive lines 3c, 3d to perform the balanced-type transmission. Because of this, the two conductive lines 3c, 3d are separately coated. Accordingly, even if a structure is employed, in which a DC voltage is applied to each of the conductive lines 3c, 3d, it is possible to decrease the risk of electricity leak.

Here, in the reception device 1 in the first embodiment and the reception device 1a in the second embodiment, the voltage values supplied from the DC power supplies 14, 15 may be different from each other. However, it is preferable to use the same voltage value because it becomes possible to achieve simplification of the structure of the regulator 8. According to this structure, in the regulator 8, for example, it becomes possible to increase and decrease the input voltage value Vr by means of a predetermined circuit and to generate a DC voltage supplied to the antenna amplifier 7 by only performing the smoothing by means of a smoothing circuit. Moreover, if the magnitude of the voltage value Vr supplied to the regulator 8 is nearly equal to the magnitude of the voltage value supplied to the antenna amplifier 7, it becomes possible to compose the regulator 8 with only a smoothing circuit. Accordingly, it becomes possible to achieve further size reduction and simplification of the reception device 1.

Besides, as for the switch control of the variable-directivity antenna 6, the connection of the switch portion 12 is switched in a case where the antenna control portion 13 detects that the reception situation deteriorates more than a predetermined situation; however, the antenna control portion 13 may check the reception situation and decide to or not to perform the switching of the connection at predetermined time intervals.

Besides, in performing the switching operation of the switch portion 12, the antenna control portion 13 may compare the reception situations before and after the switching operation with each other. Moreover, in a case where the reception situation after the switching operation deteriorates more than the reception situation before the switching operation, the switching operation may be performed again to put the reception situation back to the situation before the switch operation. Besides, in deciding the initial state of the connection of the switch portion 12, the state that brings the best reception situation may be decided as the initial state by comparing the reception situations in respective states that are achievable by the switching operation.

Besides, the antenna control portion 13 checks the reception situation and switches the switch portion 12 based on the signal output from the demodulator 11; however, the antenna control portion 13 may check the reception situation based on the signal output from the tuner portion 10.

Besides, in the present example, the structure that uses the two DC power supplies 14, 15 is described; the same structure may be employed by using one DC power supply 14a and switching the connection of the positive pole and the negative pole. A specific example is shown in FIG. 5. FIG. 5 is a circuit diagram showing another example of the DC power supply and the switch portion.

As shown in FIG. 5, a witch portion 12a in the present example includes: two terminals S2, S3; and four contacts T3 to T6. The other end of the inductor L4 is connected to the contact T3; and the other end of the inductor L3 is connected to the contact T4. Besides, the contact T5 is connected to a connection node between the inductor L3 and the contact T4; and the contact T6 is connected to a connection node between the inductor L4 and the contact T3. Besides, the positive pole of the DC power supply 14a is connected to the terminal S2; and the negative pole of the DC power supply 14a is connected to the terminal S3. Besides, the switch portion 12a goes into either of two connection states, that is, one connection state in which the terminal S2 is connected to the contact T3 and the terminal S3 is connected to the contact T5; and the other connection state in which the terminal S2 is connected to the contact T4 and the terminal S3 is connected to the contact T6. The switch control of the connection state is performed by the antenna control portion 13.

Even in this structure, by switching the connection state of the switch portion 12, it becomes possible to control the DC voltages applied to the inner conductive body 3a (conductive line 3c) and to the outer conductive body 3b (conductive line 3d) as described above. Besides, because it is possible to dispose only one DC power supply 14a, it becomes possible to achieve further size reduction and simplification of the reception devices 1, 1a. Besides, there is only one DC power supply 14a, it becomes possible to keep the DC voltage applied to the regulator 8 at a nearly constant magnitude whichever connection state is selected.

Besides, the antenna control device and the antenna control method according to the present invention may be applied to not only the above reception devices 1, 1a but also a transmission device that includes the variable-directivity antenna 6. In a case of the application to a transmission device, the directivity of the variable-directivity antenna 6 may be switched in a case where a signal indicating that the reception is normally performed is not transmitted from the reception device and the like.

### Other Embodiments

In the above first embodiment and the second embodiment, only the case where the present invention is applied to the reception device is described; however, it is possible to apply the present invention to general communication devices such as a transmission device and the like. Besides, it is possible to use the present invention for not only the control of a variable-directivity antenna but also another control. Hereinafter, as such an example, a case where the antenna control device and control method according to the present invention are applied to the transmission and reception control of a communication device that performs transmission and reception is described by using FIG. 6. FIG. 6 is a block diagram showing an overview of a structure of a communication device in another embodiment of the present invention.

As shown in FIG. 6, a communication device 20 includes: a antenna portion 21 that transmits and receives a signal; a modulation/demodulation portion 22 that modulates a signal input into the antenna portion 21 and demodulates a signal output from the antenna portion 21; a signal line 23 that connects the antenna portion 21 and the modulation/demodulation portion 22 to each other; and a signal process portion 24 that converts an input signal into a signal capable of being modulated, inputs the signal into the modulation/demodulation portion and performs a process to convert a signal output from the modulation/demodulation portion 22 into an output signal usable in an output device.

The antenna portion 21 includes: an antenna 25 that performs transmission and reception; an antenna switch portion 26 that performs the switching depending on which purpose of the transmission and the reception the antenna 25 is used for; a full-wave rectification portion 27; and a regulator 28, The antenna switch portion 26 is provided with: a filter for transmission and reception; an amplifier that amplifies a transmission signal and a reception signal and the like; in a case where transmission and reception are performed, the antenna switch portion 26 suitably switches these connections to switch a characteristic of the antenna 25. The full-wave rectification portion 27 rectifies an input voltage to continuously output an DC voltage that becomes a positive voltage value; and may be so structured as to include the full-wave rectification portion 9 shown in FIGS. 1 and 4. The regulator 28 smoothes, increases and decreases a DC voltage output from the full-wave rectification portion 27, thereby supplying a DC voltage used in the antenna switch portion 26. Besides, the DC voltage supplied from the regulator 28 is used as a power-supply voltage to drive the amplifier, the filter of the antenna switch portion 26 and the like. Here, the regulator 28 may have the same structure as the regulator 8 shown in FIGS. 1 and 4.

Besides, the modulation/demodulation portion 22 includes: a transmission and reception portion 29 that modulates or demodulates an input signal; and an antenna switch control portion 30 that applies a DC voltage to the signal line 23. The antenna switch control portion 30 has a structure to include the switch portions 12, 12a and the DC power supplies 14, 14a shown in FIGS. 1, 4, and 5; and switches the sign of a DC voltage applied to the signal line 23 like the first and second reception devices 1, 1a shown in FIGS. 1 and 4.

In switching the transmission/reception operation, the communication device 20 in the present embodiment inputs a transmission and reception switch signal into the antenna switch control portion 30. Based on this signal, the antenna switch control portion 30 switches the sign of the DC voltage applied to the signal line 23. And, based on the DC voltage that is applied to the signal line 23 and input into the antenna portion 21, the antenna switch portion 26 switches a characteristic of the antenna 25. For example, in a case where a positive voltage is applied to the signal lien 23, the antenna switch portion 26 may be switched for transmission; and in a case where a negative voltage is applied, the antenna switch portion 26 may be switched for reception.

As described above, it is also possible to apply the antenna control device and antenna control method according to the present invention to the case where the transmission and reception of the communication device 20 that performs the transmission and reception is switched. Here, the antenna switch portion 26 checks only the sign of the input DC voltage to perform the switching only. Or, the antenna switch portion 26 changes only structures of devices (the amplifier, the filter and the like) to be operated in accordance with the sign of the input DC voltage. Because of this, a switch device like the switch portion 103 in FIG. 7, which switches the connection between a transmission portion including a transmission antenna and the modulation/demodulation portion 22; and the connection between a reception portion including a reception antenna and the modulation/demodulation portion 22, becomes unnecessary. Accordingly, it becomes possible to achieve size reduction and simplification of the communication device 20.

Besides, it becomes unnecessary to dispose a modulation device, which modulates the DC voltage applied to the signal lien 23 and transmits a signal to the antenna portion 21, in the modulation/demodulation portion 22 and to dispose a demodulation device that demodulates a modulated DC voltage in the antenna portion 21. Accordingly, it becomes possible to achieve further size reduction and simplification of the communication device 20.

Besides, in the above reception devices 1, 1a and the communication device 20, a control device such as a microcomputer or the like may perform the operations of the antenna control portion 13 and the antenna switch control portion 30. Moreover, by writing all or part of the functions achieved by such a control device as a program and by executing the program on a program execution device (e.g., a computer), all or part of the functions may be achieved.

Moreover, besides the above cases, it is possible to achieve the above reception devices 1, 1a and the communication device 20 by means of hardware, or a combination of software and hardware. Besides, in a case where the reception devices 1, 1a and the communication device 20 are composed by using software, a block diagram of parts achieved by the software shows a functional block diagram of the parts.

Supra, the embodiments of the present invention are described; however, the scope of the present invention is not limited to those embodiments and it is possible to add various modifications to the present invention and put it into practical use without departing from the spirit of the present invention.

### INDUSTRIAL APPLICABILITY

The present invention relates to an antenna control device that is disposed in communication devices such as a transmission device, a reception device and the like that perform radio communication by using an electromagnetic wave, typically, broadcasting electric waves used for digital terrestrial television broadcasting, digital terrestrial voice broadcasting and the like

1. An antenna control device for a communication device that includes: an antenna portion that has an antenna which performs radio communication of a signal; and a signal conversion portion that is connected to the antenna portion via a signal line and converts a signal;
the antenna control device comprising:
a direct-current power supply that is disposed in the signal conversion portion and supplies a direct-current voltage:
a switch portion that is disposed in the signal conversion portion and switches connection between the direct-current power supply and the signal line, thereby applying a direct-current voltage that has either voltage value of a first positive voltage value and a second negative voltage value to the signal line; and
an antenna switch portion that is disposed in the antenna portion and switches a characteristic of the antenna;
wherein based on a voltage value of the direct-current voltage applied to the signal line, the antenna switch portion switches the characteristic of the antenna.

2. A reception device including:
an antenna portion that has an antenna which receives a signal; and a demodulation portion that is connected to the antenna portion via a signal line and demodulates an input signal;
the reception device comprising:
a direct-current power supply that is disposed in the demodulation portion and supplies a direct-current voltage:
a switch portion that is disposed in the demodulation portion and switches connection between the direct-current power supply and the signal line, thereby applying a direct-current voltage that has either voltage value of a first positive voltage value and a second negative voltage value to the signal line; and
an antenna switch portion that is disposed in the antenna portion and switches a characteristic of the antenna;
wherein based on a voltage value of the direct-current voltage applied to the signal line, the antenna switch portion switches the characteristic of the antenna.

3. The reception device according to claim 2, further comprising;
an antenna amplifier that is disposed in the antenna portion and amplifies a signal input into the antenna; and
a full-wave rectification portion that is disposed in the antenna portion, applies full-wave rectification to the direct-current voltage applied to and input into the signal line, thereby generating a direct-current voltage that is supplied to the antenna amplifier.

4. The reception device according to claim 2, wherein the antenna switch portion switches directivity of the antenna in a reception direction.

5. The reception device according to claim 4, wherein the antenna includes:
at least two parasitic elements whose one end is grounded; and
an electric-power reception element that is disposed between the parasitic elements and inputs a received signal into the demodulation portion via the signal line; and
the antenna switch portion includes a variable-reactance element which is disposed in each of the parasitic elements and whose reactance to a received signal is variable;
wherein the reactance of the variable-reactance element is decided based on the voltage value of the direct-current voltage applied to the signal line.

6. The reception device according to claim 5, wherein
the variable-reactance element is a varactor diode;
an anode of one of the varactor diodes is so disposed as to be situated on a one-end side of the parasitic element that is grounded;
a cathode of one of the other of the varactor diodes is so disposed as to be situated on a one-end side of the parasitic element that is grounded;
a capacitor is disposed between the varactor diode and the grounded one end of the parasitic element; and
the direct-current voltage applied to the signal line is applied across the varactor diode of the parasitic element and the capacitor.

7. The reception device according to claim 2, wherein based on the signal processed by the demodulation portion, the switch portion switches the connection between the direct-current power supply and the signal line.

8. The reception device according to claim 2, wherein the signal line is a feeder line that includes two conductive lines.

9. An antenna control method for a communication device that includes an antenna portion that has an antenna which performs radio communication of a signal; and a signal conversion portion that is connected to the antenna portion via a signal line and converts a signal;
the antenna control method comprising the steps for:
applying a direct-current voltage that has either voltage value of a first positive voltage value and a second negative voltage value to the signal line; and
controlling a characteristic of the antenna based on a voltage value of the direct-current voltage applied to the signal line.

10. The reception device according to claim 3, wherein based on the signal processed by the demodulation portion, the switch portion switches the connection between the direct-current power supply and the signal line.

11. The reception device according to claim 4, wherein based on the signal processed by the demodulation portion, the switch portion switches the connection between the direct-current power supply and the signal line.

12. The reception device according to claim 5, wherein based on the signal processed by the demodulation portion, the switch portion switches the connection between the direct-current power supply and the signal line.

13. The reception device according to claim 6, wherein based on the signal processed by the demodulation portion, the switch portion switches the connection between the direct-current power supply and the signal line.

14. The reception device according to claim 3, wherein the signal line is a feeder line that includes two conductive lines.

15. The reception device according to claim 4, wherein the signal line is a feeder line that includes two conductive lines.

16. The reception device according to claim 5, wherein the signal line is a feeder line that includes two conductive lines.

17. The reception device according to claim 6, wherein the signal line is a feeder line that includes two conductive lines.
